(19) United States
(12) Patent Application Publication
(10) Pub. No.: US 2012/0054013 A1
(43) Pub. Date: Mar. 1, 2012

(54) Universal Value Transfer Card And Method Of Using The Same

(76) Inventors: Donald J. ANDERSON, Johnston, IA (US); Jack W. LINGE, Urbandale, IA (US)

(21) Appl. No.: 12/861,998

(22) Filed: Aug. 24, 2010

(51) Int. Cl. G06Q 30/00

(52) U.S. Cl. 705/14.26

(57) ABSTRACT

A universal card having an identification code is distributed to a consumer. The consumer activates the card by accessing a website provided by an administrator. Advertisers input information into the website related to product promotions and discounts. When consumers make a purchase, both product information and card information are transmitted to the administrator. The administrator compares scanned product information and scanned card information with stored information to determine if a discount is warranted. If warranted, then discount information is transmitted to the retailer.

### BACKGROUND OF THE INVENTION

This invention is directed toward a method of providing funds or discounts to be used for the purchase of merchandise or services and more specifically toward the use of a universal card that provides the same.

The use of coupons as a discount of the price of a purchased good or service is a well-known and well-established business method of, among other things, a.) Attracting consumers and/or customers to a retailer's business location, b.) Promoting and increasing the sales of the retailer's product or service, c.) Reducing a retailer's inventory; and d.) Building consumer loyalty to the retailer.

A consumer obtains coupons from numerous sources, such as the Internet, direct mail, publications or coupon issuers. The consumer presents the coupon to a retailer at the point of sale. The retailer examines the coupon and decides whether to apply the discount. Refusing to honor an expired or counterfeit coupon at the point of sale often disturbs the purchaser and negatively affects the relationship between consumer and retailer.

If honored, the coupon is redeemed and the discount is applied to the amount of purchase. Redeemed coupons are collected and provided for sorting by middlemen such as fulfillment services or clearinghouses. These organizations often also inspect the coupons before forwarding them to the coupon issuers they have identified. Upon receipt coupon issuers may also examine the coupons to confirm their authenticity and in order to detect and avoid the occasional fraudulent practices engaged in by consumers, coupon redeemers and middlemen.

This process is time consuming, labor intensive, open to fraud, costly and cause delays in the reimbursement of retailers. Therefore, a need exists in the art for a method that improves upon this deficiency.

In addition, gift cards are well-known in the art. Typically, a gift card is purchased from a gift card issuer and given to a recipient who is required to redeem the card only at the gift card issuer's business. If the gift card is not fully redeemed at that one business, as often happens, the money used to purchase the gift card is lost by both the one providing the gift and the recipient. Recipients of the gift card are usually not permitted to a.)redeem the gift for cash, b.) use the gift card at another place of business, c.) transfer funds remaining on the gift card to another person, d.) donate the remaining funds to a charitable organization or e.) earn interest on the balance.

As a result, it is not uncommon for a consumer to receive multiple gift cards, which the consumer must be careful not to misplace, lose or damage, and that require the recipient to travel to various businesses to redeem the gift cards. Accordingly, a need exists in the art for a method of using a gift card that addresses these deficiencies.

An objective of the present invention is to provide a card and method that eliminates the need for manually processing coupons.

Another objective of the present invention is to provide a gift card where funds may be redeemed for cash, transferred to other businesses or individuals, donated to a charitable organization, and earn interest on the balance.

These and other objectives will be apparent to one of ordinary skill in the art based upon the following disclosure.

### SUMMARY OF THE INVENTION

A universal card having an identification code is distributed to a consumer. The consumer activates the card by accessing a website provided by an administrator. Advertisers input information into the website related to product promotions and discounts. When consumers make a purchase, both product information and card information are transmitted to the administrator. The administrator compares scanned product information and scanned card information with stored information to determine if a discount is warranted. If warranted, then discount information is transmitted to the retailer.

### BRIEF DESCRIPTION OF THE FIGURES

FIG. 1 is a schematic view of the environment for a universal coupon/gift card;

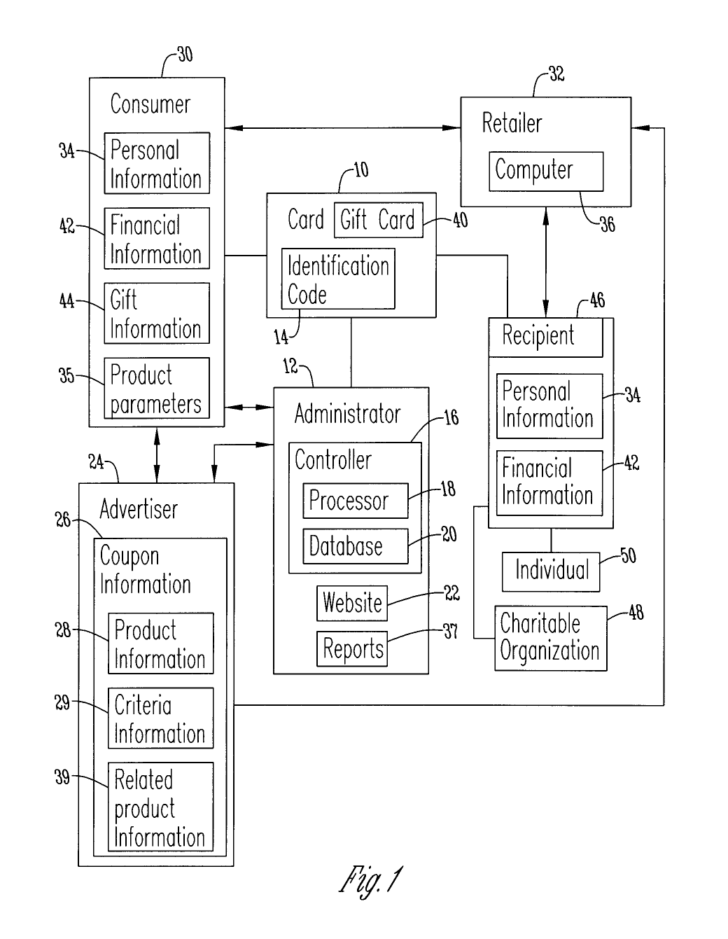

FIG. 2 is a flow diagram for a coupon card; and

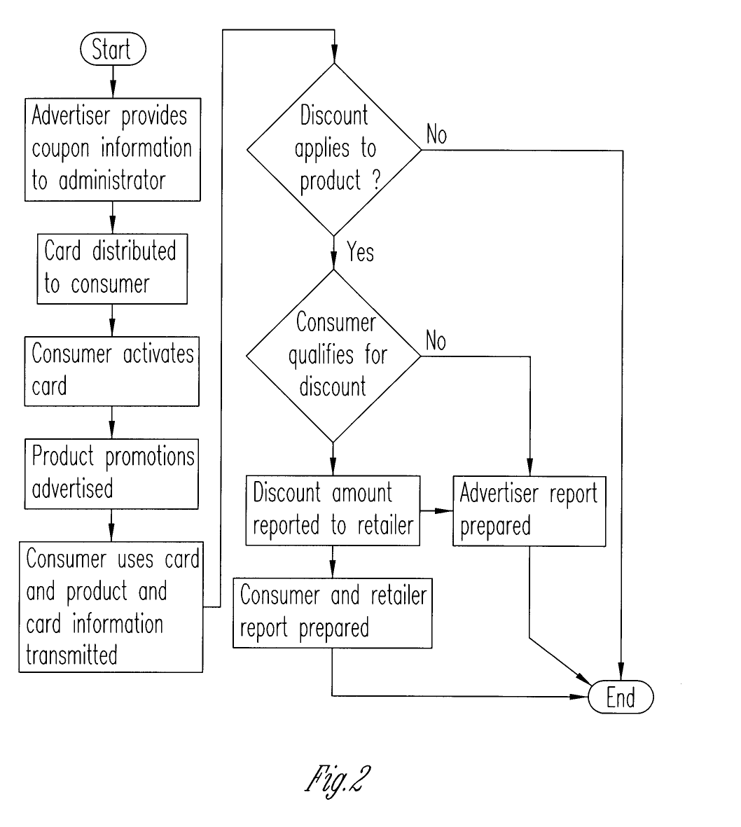

FIG. 3 is a flow diagram for a gift card.

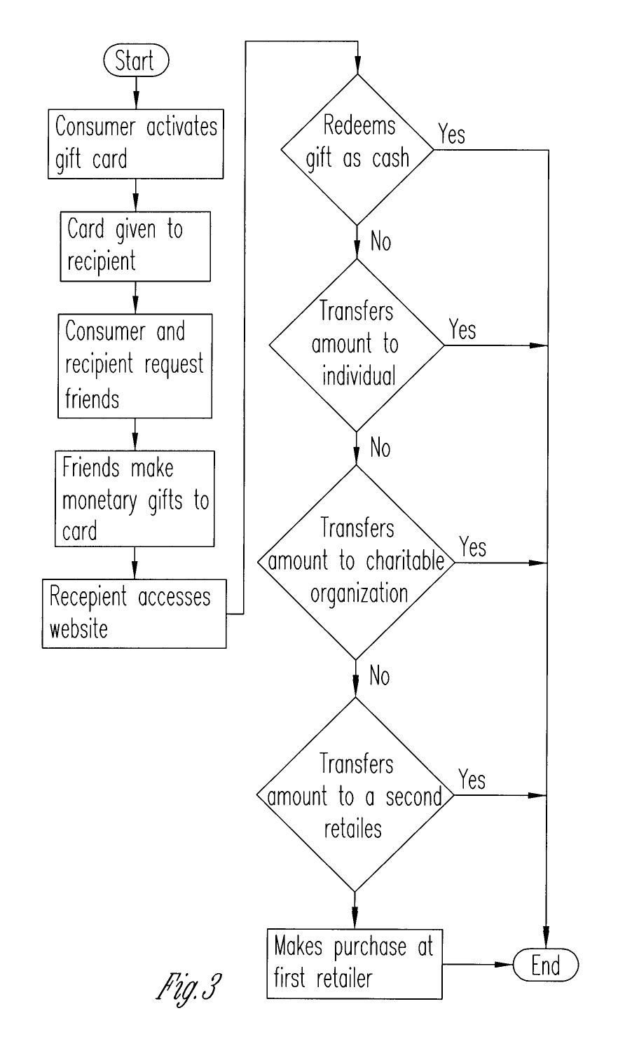

### DETAILED DESCRIPTION OF THE PREFERRED EMBODIMENT

Referring to the figures, a universal coupon card 10 is issued by a card administrator 12, and preferably each card is embossed with an identification code 14 such as a multi-digit number. Alternatively, the identification code 14 is a standard UPC bar code, 2D bar code, magnetic strip, radio frequency identification service (RFID) or the like.

The administrator 12 has a controller 16 that includes a processor 18 and at least one database 20. The database 20 is designed to store, rapidly retrieve, and compare detailed information entered by individuals and businesses. The identification code 14 of each card is stored in the database 20. The controller 16 is connected, via an electronic network to an administrator's website 22.

Advertisers 24, via the electronic network, access the website 22 through a secured manner, and enter coupon information 26. The coupon information 26 includes product information 28 such as an associated UPC bar code, product name, and price; and criteria information 29, such as the time frame for the promotion, selected retailers, amount of discount, and consumer criteria such as demographic and psychographic criteria. For convenience, the advertiser 24 is able to transfer data on its entire product line. The coupon information is stored in the database 20.

Consumers 30 receive the card 10 from the administrator 12, the advertiser 24, and/or a retailer 32. As an example, the administrator 12 or advertiser 24 mail the card directly to the consumer 30 wherein the consumer 30 is instructed to access the website 22 via an electronic network to activate the card 10. A consumer 30 activates the card 10 by entering personal information 34 such as name, address, e-mail, age, sex, occupation, income, and the like. The personal information 34 is associated with the consumer's 30 card 10 and is stored in the database 20. Alternatively, a consumer 30 receives the card 10 from a retailer 32 at the point of sale wherein the consumer 30 activates the card 10 preferably through a computer 36 located at the retailer 32.

The use of the card 10 and specific product promotions are advertised to the consumer 30 in a number of ways. One way is by the advertiser 24 through conventional channels such as newspapers, magazines, and point-of-sale displays. Another way is through direct mail and/or e-mail using the administrator's 12 database 20 to send information to consumers 30 who meet the criteria information 29. In this way, the advertiser 24 authorizes the administrator to send a coupon or notice of coupon, either electronically or by other means, to consumer 30 that meet the desired characteristics defined by the advertiser 24.

When a consumer 30 uses the card 10 at a point-of-sale, the products purchased are scanned by the retailer 32 and product information such as the UPC bar code is transmitted via an electronic network to the administrator's controller 16. The scanned product information is compared to the advertiser's product information 28 in the database 20 to determine if a discount is available for the product. Also, the card 10 is scanned by the retailer 32 and the identification code 14 is transmitted via an electronic network to the administrator's controller 16. The identification code is used to locate the consumer's personal information 34, which is then compared with the criteria information 29 to determine if the product discount is available to the consumer 30. If there is a discount associated with the scanned product and the consumer 30 meets the criteria and qualifies for the discount, then the administrator 12 transmits via the electronic network the amount to be discounted on the consumer's 30 bill to the retailer 32. The discount occurs automatically or is input manually by the retailer 32 and is displayed on the receipt. If the consumer 30 is not qualified to receive a discount, a notice is transmitted from the administrator 12 to the retailer 32.

In one embodiment, prior to making a purchase, the consumer 30 accesses the website 22 and inputs product parameters 35. Product parameters include, but are not limited to, product name, product type, product location within a specific limit (i.e., within 5 miles of home) and the like. The controller 16 then compares the product parameters 35 with the coupon information 26 and provides the consumer 30 with a report 37 listing the products, the stores where the products are located, whether a discount applies, and the price. In this manner, the consumer can select the stores where they wish to shop based upon the consumer's product parameters. In addition, the advertiser 24 may input related products 39 that are suggested to the consumer 30 based on the product parameters 35 that are included in the report.

Should the consumer 30 wish, the card 10 may be activated as a debit and/or credit card. This is done by accessing the website and providing financial information 42. Once approved, the consumer 30 may complete the purchase using the card 10.

When a discount is qualified, the controller 16 calculates, records, and stores the discount in a file for each advertiser 12, consumer 30, and retailer 32. The controller 16 also prepares reports 37 for the advertiser 12, consumer 30, and retailer 32 that are transmitted to each at predetermined times and are accessible immediately through the website 22. In one embodiment, the advertiser report includes demographic information on both consumers 30 who qualify for the product discount and those consumers who do not. In another embodiment, provisions are made for money owed by the advertiser 24 to be transferred to both the administrator 12 and the retailer 32.

As a result of using the universal coupon card 10, a consumer need not clip multiple coupons that are then collected at a retailer, reviewed by a fulfillment service, and verified by an advertiser. Instead, coupon information is stored and accessed at the administrator where transactions are verified and qualified quickly and easily.

In another embodiment, the card 10 is used as a universal gift card 40. In this embodiment, the consumer 30 activates the card 40 through the website 22, but in addition to providing personal information 34, the consumer provides financial information 42 and gift information 44. Financial information 42 includes the name and account number of the consumer's financial institution and authorization to transfer funds. The gift information 44 includes the name of the retailer, the amount of the gift, and any restriction criteria on how the gift is used. Once the gift is authorized, funds are transferred to the administrator 12 where funds are stored until a transaction is made. The funds preferably are transferred to an interest bearing account wherein the interest is distributed to the administrator 12 or a recipient 46.

The card 40 is presented to a recipient 46 by the consumer 30. Once received, other consumers (i.e., friends and family) may access the website 22 and make additional gifts as previously disclosed. The consumer 30 and/or the recipient 46 may send friend requests via the electronic network. Once accepted, friends are able to make monetary gifts and advise one another about various coupon offers. When used, the recipient 46 presents the card to the retailer 32. If the amount of the gift is insufficient to cover the purchase, the recipient 46 may pay cash for the additional amount or may transfer funds from other gifts associated with card 40. Such funds may be set to automatically transfer by the recipient 46 by accessing the website 22, and authorizing the transfer. Alternatively, the recipient 46 transfers the funds by accessing the website 22 preferably at the point of sale.

In addition, the recipient 46 may redeem the amount, or a portion thereof, on the gift card 40 for cash. This is done by accessing the website 22 wherein the recipient 46 enters personal information 34 and financial information 42 and then requests cash. When cash is requested, the administrator 12 either sends a check to the recipient 46 or transfers funds from the administrator's financial account to the recipient's financial account. The recipient 46 may also make a similar request and have the gift amount transferred to a charitable organization 48.

Alternatively, the recipient 46 may transfer all or a portion of the gift amount to another individual 50. This is done by accessing the website 22 and requesting that a gift amount be transferred to another gift card using the identification code 14. If the individual 50 does not have a gift card 40, the recipient 46 requests that a new card be created and sent to the individual 50 by entering personal information 34 on the individual. In this manner, the recipient need not retain multiple gift cards and also has greater flexibility in the use of the gift card.

What is claimed is:

1. A method of providing product discounts, comprising the steps of:
accessing a website of an administrator through an electronic network;
inputting product information and coupon criteria that is stored in a database of the administrator, the database also including stored consumer information;
transmitting product information and card information from a retailer to the administrator; and
comparing the transmitted information with the stored information to determine if a product discount should be given.

2. The method of claim 1 further comprising the step of providing a report on the product discounts.

3. The method of providing product discounts comprising the steps of:
distributing a coupon card to consumers activating the coupon card by entering personal information via an electronic network to a website provided by an administrator;
storing the personal information in a database along with product information and coupon criteria;
transmitting via an electronic network product information and card information from a retailer to an administrator; and
comparing the transmitted information with the stored information to determine if a product discount should be given.

4. A method of transferring gift funds, comprising the steps of:
activating a gift card through a website provided by an administrator via an electronic network by selecting a gift amount and a retailer;
providing the gift card to a recipient;
accessing the website to transfer the gift amount to a second retailer; and
making a purchase at the second retailer using the gift card.

5. The method of claim 4 further comprising the step of transferring funds from a consumer to the administrator upon activation.

6. The method of claim 5 further comprising the step of transferring funds from the administrator to the second retailer upon purchase.

7. The method of claim 4 further comprising the step of transferring the gift amount to an individual.

8. The method of claim 4 wherein interest is earned on the gift amount.

9. The method of claim 4 wherein at least a portion of the gift amount is redeemed as cash by the recipient.

10. A method of providing product discount information, comprising the steps of:
accessing a website via an electronic network;
inputting product parameters;
comparing the product parameters to stored coupon information; and
providing a report on products that meet the product parameters.

11. The method of claim 10 further comprising the step of providing information on related products.
